(19) United States
(12) Patent Application Publication
(10) Pub. No.: US 2013/0244499 A1
(43) Pub. Date: Sep. 19, 2013

(54) CONNECTION SYSTEM FOR AN ENERGY STORAGE DEVICE AND ENERGY STORAGE DEVICE WITH SAID CONNECTION SYSTEM

(71) Applicant: DIEHL METAL APPLICATIONS GMBH, Roethenba (DE)

(72) Inventors: Harald HECK, Nuernberg (DE); Ralf HOJDA, Altena (DE)

(73) Assignee: DIEHL METAL APPLICATIONS GMBH, Roethenbach (DE)

(21) Appl. No.: 13/788,783

(22) Filed: Mar. 7, 2013

(30) Foreign Application Priority Data
Mar. 14, 2012 (DE) 10 2012 005 120.4

(51) Int. Cl. H01R 13/00

(52) U.S. Cl. CPC H01R 13/00
USPC 439/682

(57) ABSTRACT

A connection system (1) for an energy storage device (2), wherein the energy storage device (2) comprises a plurality of cells (3), with a plurality of cell connectors (4) for electrical interconnection of the cells (3), with a storage control unit (15) for monitoring an energy supply and/or charging condition of the cells (3), with a plurality of control lines (17) for transmitting electrical signals between the cell connectors (4) and the storage control unit (15), wherein at least one of the cell connectors (4) and at least one control line (17) associated with said cell connector (4) are manufactured as a transmission element (5), jointly from a semi-finished product (6).

### BACKGROUND OF THE INVENTION

The invention relates to a connection system for an energy storage device and an energy storage device with said connection system.

### DISCUSSION OF THE PRIOR ART

Energy storage devices are used for example to store or temporarily store electrical energy. Such energy storage devices may comprise inter alia storage battery or battery packs with a plurality of cells, i.e. storage cells.

Connection systems are used as a rule for the electrical interconnection of individual cells, in particular storage battery or battery cells, and/or units of the energy storage device consisting of a plurality of cells. Corresponding connection systems may suitably interconnect the individual cells or groups of cells such that a desired target voltage can be tapped at terminals or taps of the energy storage device.

WO 2011/038908 A1 discloses a device for electrically interconnecting cells of a battery pack by means of cell connectors and a battery pack with the corresponding cell connectors. The cell connectors take the form of flexible brackets made from electrically conductive material and are mounted on a mounting plate using holding means. First conductor tracks are mounted on the mounting plate and connect the cell connectors together electrically. At least some of the cell connectors contact second, conductor tracks, likewise arranged on the mounting plate, which are designed to determine or measure operating parameters of the cells. The first and second conductor tracks are contactable via electrical plug-in connections, via intermediate contact surfaces or cable connections.

### SUMMARY OF THE INVENTION

The object of the present invention is to indicate a connection system which is improved over the prior art. The intention is in particular to provide an inexpensive and space-saving connection system for an energy storage device.

This object is achieved by a connection system having the features of claim 1 and by an energy storage device having the features of claim 15. Preferred or advantageous embodiments of the invention are disclosed by the subclaims, the following description and/or the attached figures.

A connection system is provided for an energy storage device for storing electrical energy.

The energy storage device preferably takes the form of a storage battery pack or battery pack and/or comprises at least one storage battery, storage battery pack or battery pack. The energy storage device comprises a plurality of cells, in particular storage battery or battery cells, which preferably take the form of lithium-ion cells. However, it is also possible to interconnect NiMH cells, thermal batteries and fuel cell cells. It is possible for each cell to comprise one or more subcells. Electrical energy may be stored electrically and/or chemically in the cells.

Such energy storage devices have many possible areas of use. In particular, such energy storage devices are suitable for driving electric motors of electric vehicles, for distributed storage and/or provision of electrical energy, in particular for provision of energy in aircraft. In particular, said energy storage devices may be used to buffer energy in an energy supply system. Further applications are conceivable, in particular applications in the field of alternative drive systems, in particular for hybrid, electric and fuel cell vehicles.

The connection system is preferably plate-like, i.e. configured in a plate-like shape. As a result of the plate-like shape, the energy storage device may for example be covered at those points where terminals of the cells are arranged, or in other words, as a result of the plate-like shape the connection system may overlap cell terminals, which may for example be arranged in a common cell terminal plane. The connection system is preferably designed to connect the plurality of cells of the energy storage device together electrically, such that a total voltage arising in accordance with interconnection of the cells brought about by means of the connection system may be tapped.

For electrical interconnection of the cells, the connection system comprises a plurality of cell connectors. Preferably, when the connection system is placed on the energy storage device, the cell connectors each contact a positive and a negative terminal of two cells, in order to connect the two cells together electrically. The cell connector may for example be rectangular in shape or have an outer contour in the form, for example, of a rectangular strip. In this case, the cell connector is dimensioned such that, to produce an electrical connection, it may extend from the positive terminal of the one cell to the negative terminal of the other one of the cells to be connected. In addition to the above-described series connection, parallel connection of the cells is also possible.

The connection system further comprises a storage control unit in particular for monitoring the status of the cells, in particular for monitoring the energy supply or charging condition of the cells. Furthermore, the connection system comprises a plurality of control lines, which are suitable and/or designed for transmitting electrical signals between the cell connectors and the storage control unit. By way of the transmitted signals, the storage control unit detects and/or identifies and/or monitors the status, in particular energy supply or charging condition, of the cells interconnected, i.e. connected together electrically, by the cell connector.

According to the invention, at least one of the cell connectors and at least one control line associated with said cell connector or belonging to said cell connector are manufactured as a transmission element jointly, in particular in one piece, from a semi-finished product.

The semi-finished product takes the form, for example of a wound metal strip, in particular of a “coil”. In particular, the cell connector and the control line associated therewith are separated, in particular punched, as the transmission element from the semi-finished product, in particular metal strip, during manufacture and in particular simultaneously, in particular as a unit. The cell connector and associated control line thus form a one-piece unit. The at least one cell connector and the at least one control line associated with the cell connector are made in particular from a common material portion of the semi-finished product.

It is preferable for a plurality of transmission elements, comprising in each case cell connector and control line, to be manufactured in one manufacturing operation, in particular together and/or simultaneously. To this end, the plurality of transmission elements may be separated from the semi-finished product for example spacedly next to one another, together and/or simultaneously. The transmission elements necessary at least for a portion of the connection system, or optionally even all the transmission elements of a connection system, are preferably separated simultaneously from the semi-finished product.

Because the cell connector and the control line associated with the cell connector, which together form the transmission element, may be manufactured jointly from the semi-finished product, the connection system may be simplified or optimized in terms of design, structural space, costs and service reliability.

It is particularly advantageous that the transmission element is formed in one part or one piece and that the step of producing an otherwise necessary electrically conductive connection between the cell connector and the control line may be dispensed with. Costs may in particular be saved because “dissimilar weld joints”, which would otherwise be necessary between the cell connectors and the control lines, are dispensed with.

Because in particular dissimilar weld joints or other electrical contacts and connections between cell connector and control line are absent or not needed, comparatively advantageous electrical properties may also be achieved for the transmission element.

Furthermore, due to the transmission elements being made in one piece and from one material, in particular being of monolithic configuration, simple and quick fitting in the connection system is advantageously achieved. It is furthermore worthy of mention that structural space may be saved in the connection system due to the transmission elements being produced in one piece from the semi-finished product. In addition, the proposed transmission elements also enable weight to be saved.

In a preferred configuration of the invention, the transmission element takes the form of a punched part. The transmission element is preferably punched out of the semi-finished product, in particular the metal strip, specifically out of the coil, during production.

In one preferred embodiment, the transmission element is punched out of a stepped strip, which exhibits different thicknesses in the punching region, in particular a first and a second thickness. The stepped strip is preferably configured such that and/or punching is performed such that the cell connector of the transmission element displays the first thickness and the control line, associated with the cell connector, of the transmission element displays the second thickness. The first thickness is particularly preferably greater than the second thickness.

For example, the cell connector of the transmission element displays the first thickness of at most 3.0 mm, preferably 2.0 mm, 1.5 mm or 1.2 mm. The control line associated with the cell connector exhibits the second thickness of preferably at most 1.5 mm, preferably 1.0 mm, 0.7 mm, or 0.5 mm. In a preferred configuration, the first thickness of the cell connector amounts to approximately 1.2 mm and the second thickness of the control line to approximately 0.5 mm.

By giving the cell connector and the control line different thicknesses, it is possible to take account of the generally different current carrying capacities required by each of the two elements. This means that the thickness of the electrical conductor segments of the transmission element may be selected to correspond to the respective current carrying capacity, by using a stepped strip with correspondingly stepped thicknesses as the semi-finished product. As a rule, a higher current will flow through the cell connector than through the control line. By reducing the thickness of the control line relative to the cell connector, it is possible to save material and thus weight.

In a particularly preferred configuration of the invention, at least two transmission elements are arranged in a row. To this end at least two of the cell connectors are preferably arranged spacedly in the row, in particular aligned with one another or one behind the other, wherein the control lines associated with the respective cell connectors extend away from each of the cell connectors arranged in the row. The cell connectors and/or the control lines are preferably in a common plane.

The control lines may extend in a suitable line guide towards the storage control unit or towards a receptacle or interface provided for the storage control unit.

As an optional supplementary feature, the row of at least two cell connectors and respectively associated control lines further comprises two tapping devices, which are suitable and/or designed for tapping an electrical voltage generated by the energy storage device, i.e. an electrical voltage generated by the cells connected by the cell connectors.

In particular, a plurality of the transmission elements and, optionally additionally, the two tapping devices constitute components which together form a “leadframe” of the connection system. The leadframe takes the form, for example, of a punched grid punched from the semi-finished product.

The leadframe is preferably encapsulated with plastics by injection moulding on, during or directly after punching, such that the components forming the leadframe are connected together reliably, in particular bonded, cannot fall apart, and are protected at least in part from corrosion.

In a particularly preferred configuration of the invention, the connection system comprises a first and a second leadframe. In this case it is preferable for one of the two leadframes to comprise all the above-stated components, i.e. at least two cell connectors, the control lines associated with the cell connectors and the two tapping devices, the other one of the two leadframes preferably only comprising at least two cell connectors and associated control lines.

In one preferred structural embodiment of the invention, the cell connectors arranged in a row of the first leadframe and the cell connectors arranged in a row of the second leadframe extend in the same direction as one another, in particular in symmetrical arrangement relative to a central plane between the rows. Preferably, the row of cell connectors of the first leadframe is parallel to the row of cell connectors of the second leadframe.

In one preferred embodiment of the invention, the first leadframe is formed from a first semi-finished product portion and the second leadframe from a second semi-finished product portion of the semi-finished product. In particular, the two leadframes are made from the same semi-finished product, in particular the same coil, or from the same type of semi-finished product. Thus the two leadframes have the same starting material.

It is particularly preferable for the first and second leadframes to be arranged in a common carrier part. Preferably, the two leadframes are integrally bonded into the common carrier part. As already mentioned above, the two leadframes are in particular encapsulated by injection moulding with the plastics forming the carrier part.

The carrier part may for example be rectangular-shaped, in particular rectangular, the two leadframes being arranged on longitudinal sides of the rectangular carrier part, or possibly extending along the longitudinal sides. In a preferred configuration of the connection system, the storage control unit or the receptacle or interface provided therefor is arranged in the carrier part between the two leadframes.

The carrier part preferably comprises the receptacle or interface for the storage control unit. The storage control unit and the receptacle or interface are preferably configured such that the storage control unit may be inserted, in particular detachably, into the receptacle, it preferably being inserted simply and held sufficiently firmly therein.

It is feasible, for the purposes of the invention, for the storage control unit to be removable from the receptacle again, if needed, without damage and/or non-destructively. The storage control unit is preferably pressed and/or clipped into the receptacle and/or locked therein and/or held in some other way in the receptacle by mechanical joints. However, to fasten the storage control unit in the receptacle other types of joint are also feasible, in particular soldered joints, welded joints, crimp connections, caulking and the like. Soldered and welded joints may for example be formed at electrical contact elements between storage control unit and the interface.

Overall, interlocking, non-interlocking and/or bonded joints are suitable for holding and fastening the storage control unit in the receptacle. In addition to the above-mentioned separable joints, inseparable joints are also feasible. It is for example possible for the storage control unit inserted into the receptacle to be secured by a substantially inseparable, i.e. not straightforwardly separable, welded or soldered joint, optionally after a functional check.

In a preferred configuration of the connection system, the carrier part comprises first contact springs with freely accessible first contact surfaces. Preferably, the contact springs are formed by end regions of the control lines arranged in the carrier part, in particular integrated therein. In particular, the control lines are injection moulded into the carrier part in such a way that the end regions thereof are exposed, in particular project out of the carrier part. It is particularly preferable for the end regions to be bent. In one preferred structural embodiment of the invention, the end regions of the control lines, in particular the contact surfaces thereof, adjoin the side regions of the receptacle for the storage control unit.

The storage control unit optionally comprises second contact springs with second contact surfaces. Preferably, the second contact springs with the second contact surfaces contact the first contact springs on the first contact surfaces when the storage control unit is inserted into the receptacle or interface. When the storage control unit has been inserted and on contact closure of first contact springs with corresponding second contact springs, signal transmission may be ensured between the storage control unit and the cell connectors, and thus the cells of the energy storage device. Respectively corresponding first contact springs and second contact springs may preferably be connected together by an interlocking, non-interlocking and/or bonded joint.

The semi-finished product is conveniently made from a sheet metal material with sufficient current conducting capacities. For example, the semi-finished product may be made from copper or a copper alloy. However, it is particularly preferable for the semi-finished product to be made from aluminium or an aluminium alloy, for example from Al 99.5, or from copper or a copper alloy. This has the advantage that the connection system is of lower weight and is cheaper to produce than for example an embodiment using copper or the copper alloy. If the connection system is used in an energy storage device intended for driving an electric vehicle, the weight reduction may for example lower the energy consumption of the electric vehicle.

When made from aluminium or the aluminium alloy, the semi-finished product is particularly preferably plated, e.g. roll-bonded, and/or coated at least partially and/or in places with another material. Preferably, at least electrical contact points of the semi-finished product are plated and/or coated accordingly. A material corresponding to the material of the cell terminal to be contacted is preferably used during plating or coating. Particularly suitable materials are aluminium, silver, tin, gold and alloys thereof, in particular copper alloys and aluminium alloys.

If for example the cell terminals are made of copper or a copper alloy or are coated therewith, the cell connectors are preferably at least partially coated with copper or a copper alloy. This is advantageous in terms of electrical conductivity or material compatibility and in terms of transition resistances.

In general, the surfaces brought into electrical contact, in particular the cell terminals, cell connectors etc., should consist of electrically compatible materials. If the core materials of the corresponding elements are incompatible or are less readily compatible, it is possible, as already mentioned in the above example, to use suitable coatings.

In one preferred embodiment of the invention, the second contact springs are made from a copper alloy, in particular bronze or a bronze alloy, for example CuSn6, or brass or a brass alloy. Various coating materials may be used, depending on the material combinations. Possible coating materials are in particular: copper, aluminium, silver, tin, gold, and alloys containing the stated elements, alloys in general, in particular copper alloys and the like. When selecting the coating, it should be ensured that advantageous transition resistances are obtained between the electrical contacts to be connected. In particular, comparatively high long-term stability or low ageing of the coatings should be ensured, i.e. for example the transition resistances should change as little as possible over time. In addition to improving transition resistances, coatings also add an anti-corrosive function, which should likewise be long-term and stable over time.

The present invention also provides an energy storage device with the connection system according to Claim 1 and/or any desired configuration or variant thereof. Reference is made in particular, to the above description. The energy storage device preferably takes the form of a storage battery pack or battery pack. The energy storage device is preferably a high-voltage accumulator, in particular for vehicles, in particular electric vehicles. However, low-voltage applications are also conceivable, in particular low-voltage accumulators.

It is likewise feasible, for the purposes of the invention, for the energy storage device to be suitable for use in stationary applications, in particular as energy storage means or temporary storage means, in particular in power grids. In particular, the energy storage device may be designed to ensure, as a voltage and energy source, electromotive traction or electromotive drive. It is also feasible for the energy storage device to be provided and used in aeronautical applications, in particular in aircraft, to supply energy and/or emergency power.

### BRIEF DESCRIPTION OF THE DRAWINGS

Further features, advantages and effects of the invention are revealed by the following description of preferred exemplary embodiments. In the figures:

FIG. 1 is a perspective plan view of a connection system for an energy storage device;

FIG. 2 shows the connection system and energy storage device of FIG. 1;

FIG. 3 shows an alternative representation of the connection system of FIG. 1;

FIG. 4 shows a carrier plate with a plurality of cell connectors and control lines;

FIG. 5 shows a transmission element, made from a semi-finished product, of the connection system of FIG. 1;

FIG. 6A is a plan view of a first leadframe of the connection system of FIG. 1;

FIG. 6B is a plan view of a second leadframe of the connection system;

FIG. 7 is a detail view of a receptacle arranged in the carrier plate of FIG. 5 for a storage control unit from FIG. 5;

FIG. 8 shows a storage control unit of the connection system of FIG. 1;

FIG. 9 is a detail view of contact between the storage control unit of FIG. 7 and the leadframes of FIGS. 6a, 6b.

Corresponding or identical parts are provided with the same reference numerals in each of the figures.

### DETAILED DESCRIPTION OF THE INVENTION

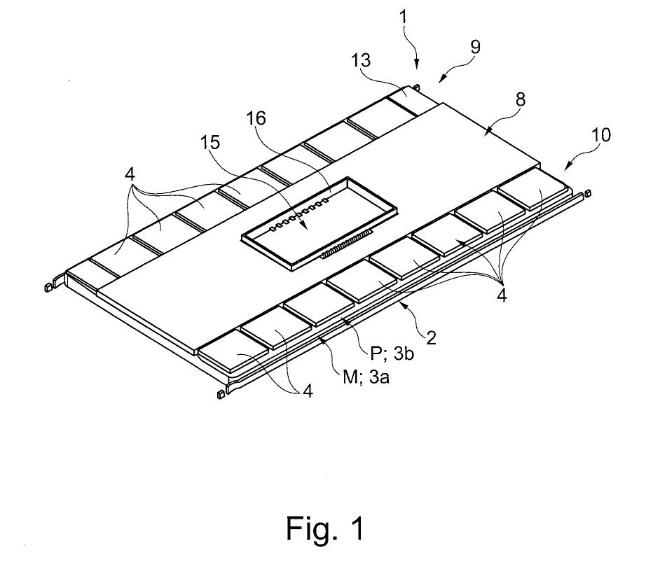

FIG. 1 is a perspective plan view of a connection system 1 constituting one exemplary embodiment of the invention. The connection system 1 is suitable and/or configured for arrangement on an energy storage device 2, covering the latter. To this end, the connection system 1 is of plate-like configuration, exhibiting roughly the same outer contour lengthwise and sideways as the energy storage device 2.

The energy storage device 2 may take the form of a storage battery pack or battery pack acting as a voltage source for ensuring drive of a motor, for example in electric vehicles. Other applications already mentioned above of the energy storage device 2, such as for example as a mobile/stationary temporary storage means in energy networks or power grids, in aeronautics or in armaments.

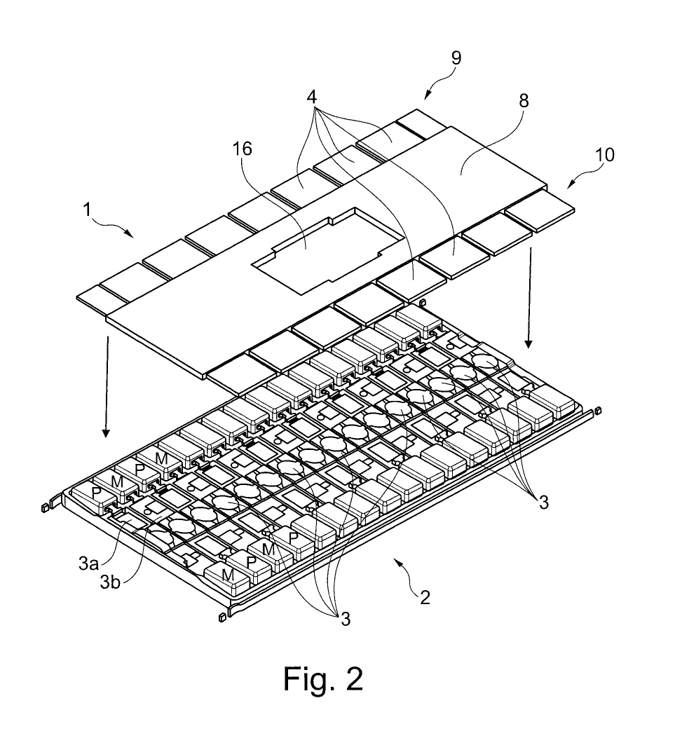

According to the detail shown in FIG. 2, the energy storage device 2 comprises a plurality of cells 3, in particular lithium ion storage batteries or batteries. The cells 3 are arranged adjacent one another to form a block or pack. Each cell 3 has a positive and negative terminal P, M, the negative terminal M of a second cell 3b being arranged next to the positive terminal P of a first cell 3a.

As FIG. 1 shows, the connection system 1 arranged on the energy storage device 2 comprises a plurality of cell connectors 4. The cell connectors 4 comprise a rectangular outer contour and are arranged spacedly and in an electrically insulated manner next to one another in first and second rows 9, 10.

The cell connectors 4 arranged in the two rows 9, 10 are integrated into the connection system 1 in such a way that when the latter is laid on the energy storage device 2 each cell connector 4 covers a positive terminal P and a negative terminal M of two adjacent cells 3a, 3b. The two cells 3a, 3b are thus interconnected electrically via the cell connector 4 covering the terminals P, M.

The connection system 1 comprises a storage control unit 15, which may be arranged in a carrier plate 8 between the two rows 9, 10 in a receptacle 16 provided therefor.

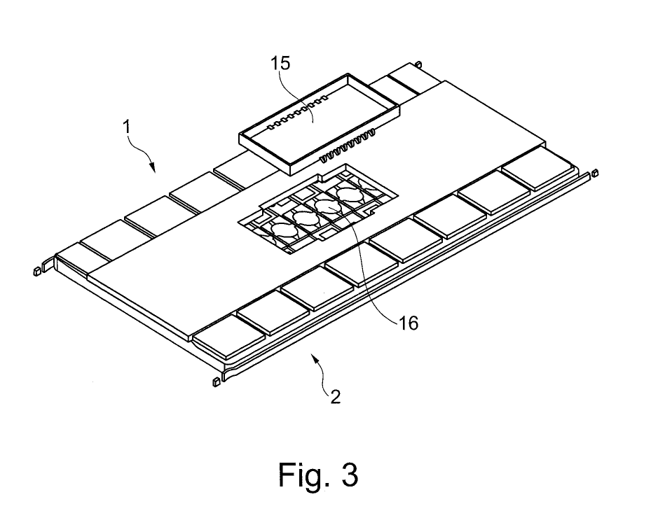

According to FIG. 3, the storage control unit 15 may be inserted into the receptacle 16 and optionally also removed again therefrom without the latter being damaged or destroyed. This is especially advantageous if the storage control unit 15 is defective and needs to be replaced.

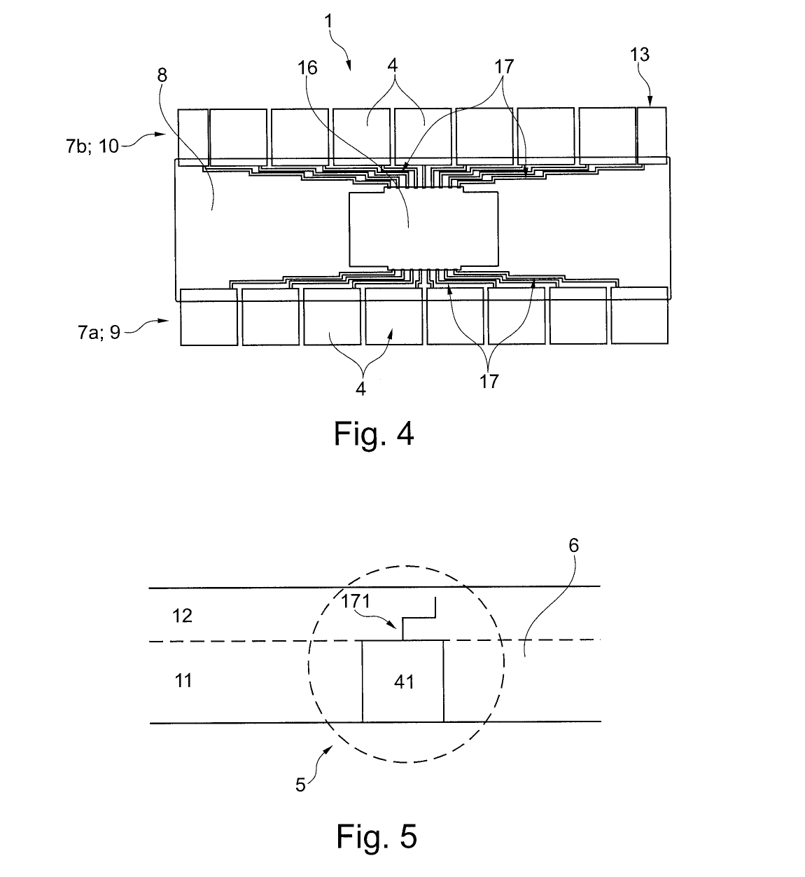

As shown in FIG. 4, the connection system 1 comprises a plurality of control lines 17, one control line 17 being associated with each cell connector 4. The control lines 17 connect the cell connectors 4 associated therewith to the storage control unit 15 which can be arranged in the receptacle 16. Electrical signals may be transmitted via the cell connectors 4 and the associated control lines 17 between the cells 3 of the energy storage device (see FIG. 2) and the storage control unit 15. By means of these signals, the storage control unit 15 monitors the energy supply and/or charging condition of the cells 3.

According to FIG. 5, at least one of the cell connectors 41 and at least one control line 171 associated with the cell connector 41 form a transmission element 5. The transmission element 5 is punched out of a semi-finished product 6, in particular out of a wound metal strip, or “coil”, the metal strip being formed of aluminium or an aluminium alloy. This means that both, in particular the cell connector 41 forming the transmission element 5 and the associated control line 171, are produced as a punched part from the semi-finished product 6. Thus, the cell connector 41 and the control line 171 are formed in one piece, in particular connected together in one piece and/or made of a single material.

The metal strip forming the semi-finished product 6 takes the form of a stepped strip with a first thickness 11 and a second thickness 12, the first thickness 11 being greater than the second thickness 12. The transmission element 5 is punched out of the semi-finished product 6 in such a way that the cell connector 41 displays the first thickness 11, of 1.2 mm. The control line 171 associated with the cell connector 41 displays the second thickness 12, of 0.5 mm.

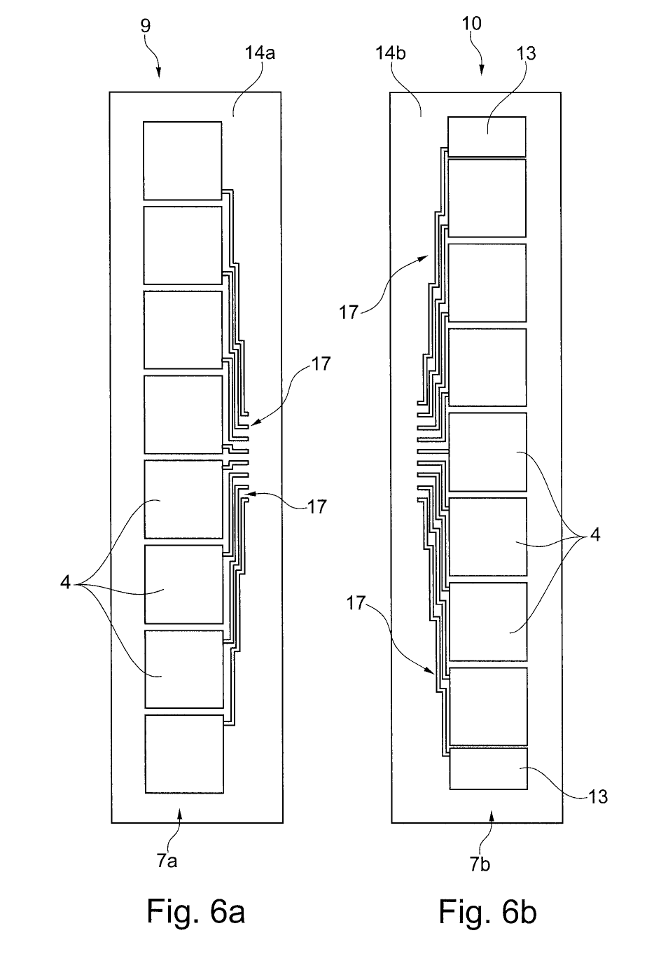

FIGS. 6a and 6b show that a plurality of transmission elements 5 are punched spacedly next to one another from the same semi-finished product portion 14a, 14b. According to FIG. 6a, eight transmission elements 5 arranged in the first row 9 form a first leadframe 7a. FIG. 6b shows a second leadframe 7b, which comprises seven transmission elements 5 arranged in the second row 10 and additionally also two tapping devices 13. The tapping devices 13 are arranged at the ends of the second row 10 and thus display the same first thickness 11 as the cell connectors 4. By way of the two tapping devices 13, an electrical power generated by the energy storage device 2 may be tapped and transmitted for example to the motor.

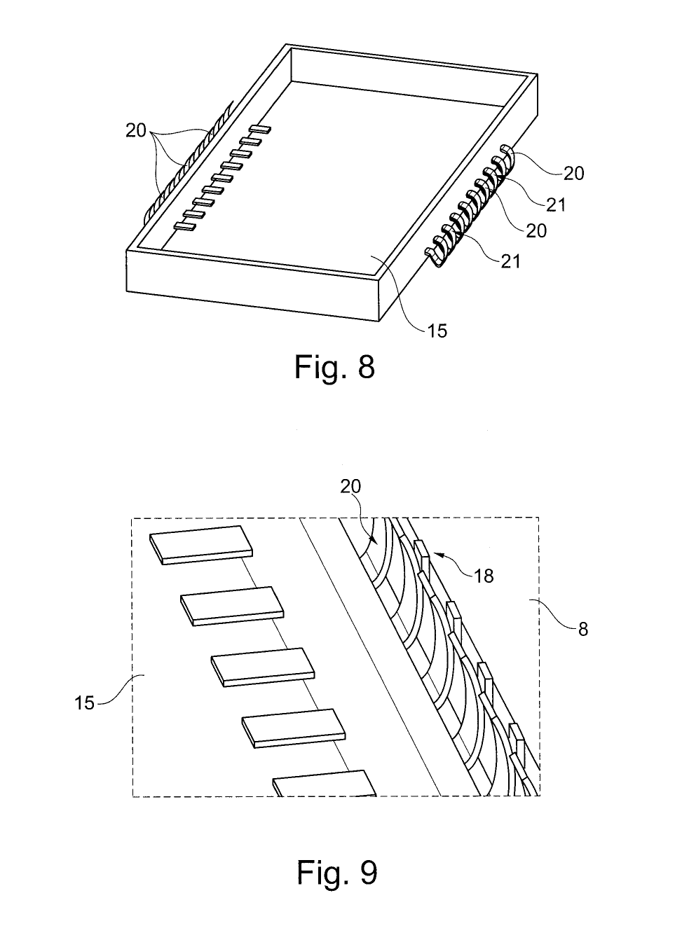

The tapping devices 13 additionally make it possible for the energy storage device 2 to be connected to an external energy source. In this way, the cells 4 (see FIG. 2), in particular when configured as storage battery cells, may be recharged with new energy. The charging process is controlled by the storage control unit 15 (see FIG. 3 or 8). This detects the charging condition of the cells 4 and accordingly controls which of the cells 4 have to be charged to a greater or lesser extent. At the same time it is possible for individual ones of the cells 4 to be supplied with additional charging energy via the control lines 17, to compensate cell charging differences.

The two leadframes 7a, 7b shown in FIGS. 6a, 6b are punched from the same material, the first leadframe 7a being made from a first semi-finished product portion 14a and the second leadframe 7a being made from a second semi-finished product portion 14b. Thus the two leadframes 7a, 7b originate as punched parts from the same or identical semi-finished product 6.

As shown in FIG. 4, the first and second leadframes 7a, 7b are incorporated in a bonded manner into the common carrier part 8, in particular injection-moulded therein. For instance, the leadframes 7a, 7b are encapsulated with plastics by injection moulding on and/or directly after their production and are held together thereby. The leadframes 7a, 7b are encapsulated by injection moulding in such a way that the cell connectors 4 of the first leadframe 7a arranged therein in a row are arranged in the same direction or even parallel to the cell connectors 4 arranged in a row of the second leadframe 7b. Thus, the leadframes 7a, 7b extend in the manner of rails along the longitudinal sides of the carrier part 8.

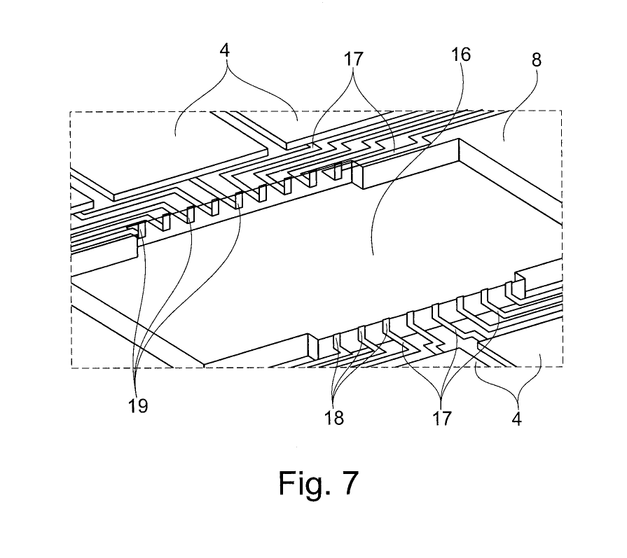

FIG. 7 is a detail view of the carrier plate 8 with the receptacle 16 for the storage control unit 15 and the control lines 17 injected into the carrier part 8. The control lines 17 extend from the cell connectors 4 to side regions, in particular to longitudinal sides of the receptacle 16, where they have bent end regions 18. These bent end regions 18 form first contact springs 18 for the storage control unit 15 insertable into the receptacle 16. The first contact springs 18 comprise first contact surfaces 19 on the side directed towards the receptacle 16.

The cell connectors 4 and the control lines 17 are formed, for cost and weight reasons, of aluminium or an aluminium alloy. To improve electrical signal transmission between the cells 3 and the storage control unit 15 (FIG. 1), the first contact springs 18, or at least the first contact surfaces 19, are coated, in particular roll-bonded, with copper or a copper alloy. Other coating materials are also feasible, in particular silver, tin, gold and alloys thereof.

In an alternative exemplary embodiment, the cell connectors 4 and the control lines 17 are formed completely of copper or the copper alloy. In this case, roll-bonding of the first contact springs 18 may accordingly be dispensed with, since they already have surfaces corresponding to the surface material of the cell connectors. In general, the plating and/or coating should be selected such that the elements or surfaces coming into contact have the same or similar material properties and compositions, in particular in terms of electrical properties. The core of the respective elements, placed under the corresponding surface, is here initially of little relevance.

In particular, electrically conductive elements used in the connection system may comprise cores of copper, copper alloy, aluminium or aluminium alloy or a plating composite of copper and aluminium and/or alloys thereof. For adaptation purposes, in particular for adaptation or optimization of the transition resistances, the elements coming into contact, in particular corresponding contact points, are preferably provided with corresponding coatings or platings.

FIG. 8 is a detail representation of the storage control unit 15. The storage control unit 15 comprises a plurality of bent second contact springs 20. The second contact springs 20 project from the longitudinal sides of the storage control unit 15 and comprise second contact surfaces 21 on the side remote from the storage control unit 15.

The second contact springs 20 are formed of copper or a copper alloy, for example brass, a brass alloy, bronze or a bronze alloy. To improve contacting and signal transmission between the contact surfaces 19, 21 of the first and second contact springs 18, 20, the second contact springs 20, or at least the second contact surfaces 21 thereof, may be provided with a coating or plating corresponding to the surface of the first contact springs 18 or adapted to the surface finish of the first contact springs 18. Depending on the core and surface of the first contact springs 18, coatings/platings comprising copper, silver, gold, aluminium, tin and alloy materials with the stated elements are suitable for the second contact springs 20.

In general, the following combinations are particularly suitable as contact pairings between elements brought into contact with one another for current conduction purposes: copper-copper, aluminium-aluminium, coated copper-aluminium, copper-coated aluminium, coated copper-coated aluminium. The term “coated” is here intended to cover coating and plating. Even with combinations of the same type, such as for example copper-copper or aluminium-aluminium, coatings, for example of silver, gold, tin and others, may be used, in particular to protect against corrosion. It is clear overall that the elements to be contacted may comprise identical or different cores, coatings and/or platings ensuring that contact surfaces of the same type come into contact with one another.

FIG. 9 shows that the first and second contact springs 18, 20 come into contact at their contact surfaces 19, 21 when the storage control unit 15 has been inserted into the receptacle 16. Because the first and second contact surfaces 19, 21 come into contact, the electrical connection is produced for signal transmission between the storage control unit 15 and the cell connectors 4 and thereby the cells 3 of the energy storage device 2 (see FIG. 2). This enables monitoring of the energy supply and/or charging condition of the cells 3 and control of the charging process, in particular an amount of energy to be charged, by the storage control unit 15.

### LIST OF REFERENCE SIGNS

1 Connection system
2 Energy storage device
3 Cells
4 Cell connectors
5 Transmission element
6 Semi-finished product
7 Leadframe
8 Carrier plate
9 First row
10 Second row
11 First thickness
12 Second thickness
13 Tapping devices
14 Semi-finished product portion
15 Storage control unit
16 Receptacle
17 Control lines
18 End regions/first contact springs
19 First contact surfaces
20 Second contact springs
21 Second contact surfaces

What is claimed is:

1. A connection system for an energy storage device, wherein the energy storage device comprises a plurality of cells,
with a plurality of cell connectors for electrical interconnection of the cells,
with a storage control unit for monitoring the energy supply and/or charging condition of the cells,
with a plurality of control lines for transmitting electrical signals between the cell connectors and the storage control unit,
wherein
at least one of the cell connectors and at least one control line associated with said cell connector are manufactured as a transmission element, jointly from a semi-finished product.

2. The connection system according to claim 1, wherein the transmission element takes the form of a punched part.

3. The connection system according to claim 1, wherein the transmission element is punched out of a stepped strip with a first and a second thickness, wherein the cell connector displays the first thickness and the control line displays the second thickness and wherein the first thickness is greater than the second thickness.

4. The connection system according to claim 1, wherein at least two of the cell connectors are arranged spacedly in a row and the respective associated control line extends from each cell connector to the storage control unit or to a receptacle provided therefor, wherein the cell connectors of the row and the associated control lines together form a “leadframe”.

5. The connection system according to claim 4, comprising a first and a second leadframe, wherein the cell connectors arranged in the row of the first leadframe and the cell connectors arranged in the row of the second leadframe extend in the same direction.

6. The connection system according to claim 5, wherein the first leadframe is formed from a first semi-finished product portion and the second leadframe is formed from a second semi-finished product portion of the semi-finished product.

7. The connection system according to claim 5, wherein the first and second leadframe are arranged in a common carrier part.

8. The connection system according to claim 7, wherein the first and second leadframes are incorporated in a bonded manner into the common carrier part.

9. The connection system according to claim 7, wherein the carrier part comprises a receptacle for the storage control unit, into which the storage control unit may be inserted.

10. The connection system according to claim 7, wherein the carrier part comprises first contact springs with freely accessible first contact surfaces, which are formed by end regions of the control lines arranged in the carrier part.

11. The connection system according to claim 10, wherein the storage control unit comprises second contact springs with second contact surfaces, which contact the first contact springs at the first contact surfaces on insertion of the storage control unit into the receptacle and ensure signal transmission between the storage control unit and the cell connectors, wherein respectively corresponding first contact springs and second contact springs are preferably connected together by an interlocking, non-interlocking and/or bonded joint.

12. The connection system according to claim 1, wherein the semi-finished product is formed from aluminium, an aluminium alloy, copper or a copper alloy.

13. The connection system according to claim 12, wherein the semi-finished product is plated and/or coated at least partially and/or in places, but at least at electrical contact points, with another material selected from the group comprising copper, aluminium, silver, tin, gold and alloys thereof, in particular copper alloys and aluminium alloys.

14. The connection system according to claim 12, wherein the second contact springs are formed from a copper alloy, preferably coated at least partially with another material.

15. The connection system according to claim 14, wherein the copper alloy is bronze, a bronze alloy, brass or a brass alloy.

16. The connection system according to claim 14, wherein said another material is silver, tin and/or gold and/or alloys with at least one of the elements silver, tin, and/or gold.

17. An energy storage device having the connection system according to claim 1.
